(19) United States
(12) Patent Application Publication
(10) Pub. No.: US 2017/0115877 A1
(43) Pub. Date: Apr. 27, 2017

(54) ELECTRONIC DEVICE AND METHOD FOR CORRECTING CHARACTER

(71) Applicant: Chiun Mai Communication Systems, Inc., New Taipei (TW)

(72) Inventor: WEN-YANG LIU, New Taipei (TW)

(21) Appl. No.: 15/001,722

(22) Filed: Jan. 20, 2016

(30) Foreign Application Priority Data
Oct. 23, 2015 (CN) 201510697269.4

(51) Int. Cl. G06F 3/0489; G06F 3/0482; G06F 3/0488

(52) U.S. Cl. CPC G06F 3/04895; G06F 3/04886; G06F 3/0482; G06F 3/04883

(57) ABSTRACT

A character correcting method using an electronic device includes displaying a virtual keyboard that includes a plurality of character keys on a display device. A character corresponds to one of the plurality of character keys is outputted. A wrong character is determined when a delete key on the virtual keyboard is touched. Multiple candidate keys are determined according to a position of a character key that corresponds to the wrong character on the virtual keyboard. The candidate keys are displayed on a generated window. Once one of the candidate keys on the window is touched, the wrong character is replaced with a character that corresponds to the one of the candidate keys.

### CROSS-REFERENCE TO RELAYED APPLICATIONS

This application claims priority to Chinese Patent Application No. 201510697269.4 filed on Oct. 23, 2015, the contents of which are incorporated by reference herein.

### FIELD

The subject matter herein generally relates to managing technology, and particularly to an electronic device and a method for correcting a character using the electronic device.

### BACKGROUND

An electronic device such as a mobile phone can provide a virtual keyboard to input characters. However, a wrong character may be inputted if the user touches a key carelessly.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device.

FIG. 2 is a block diagram of one embodiment of modules of a correcting system installed in the electronic device of FIG. 1.

FIG. 3 illustrates a flow chart of one embodiment of a method for correcting a character using the electronic device.

FIGS. 4A-4C illustrates one example of displaying a window on a virtual keyboard.

FIG. 5 illustrates one example of a touch area on the virtual keyboard.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

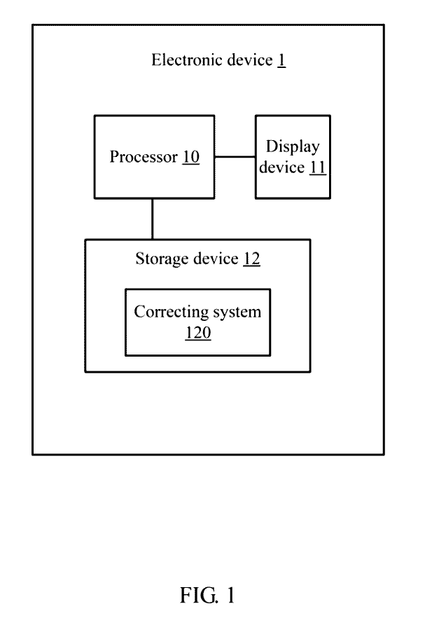

FIG. 1 is a block diagram of one embodiment of an electronic device. Depending on the embodiment, an electronic device 1 may include, but are not limited to, at least one processor 10, a display device 11, and a storage device 12. The above components are electrically connected to each other. The electronic device 1 can be a mobile phone, a tablet personal computer, or any other suitable device. FIG. 1 illustrates only one example of the electronic device 1 that can include more or fewer components than illustrated, or have a different configuration of the various components in other embodiments.

The at least one processor 10 can be a central processing unit, a microprocessor, or any other chip with data processing function.

The display device 11 can provide an interface for interaction between a user and the electronic device 1. In one embodiment, the display device 11 is a touch screen.

The storage device 12 can be an internal storage device, such as a flash memory, a random access memory (RAM) for temporary storage of information, and/or a read-only memory (ROM) for permanent storage of information. The storage device 12 can also be an external storage device, such as a smart media card, a secure digital card, and/or a flash card.

In at least one embodiment, a correcting system 120 is installed in the electronic device 1. The correcting system 120 can include one or more modules that are stored in the storage device 12, and are executed by the at least one processor 10 to correct a wrong character.

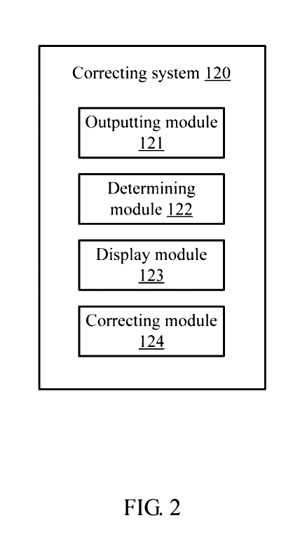

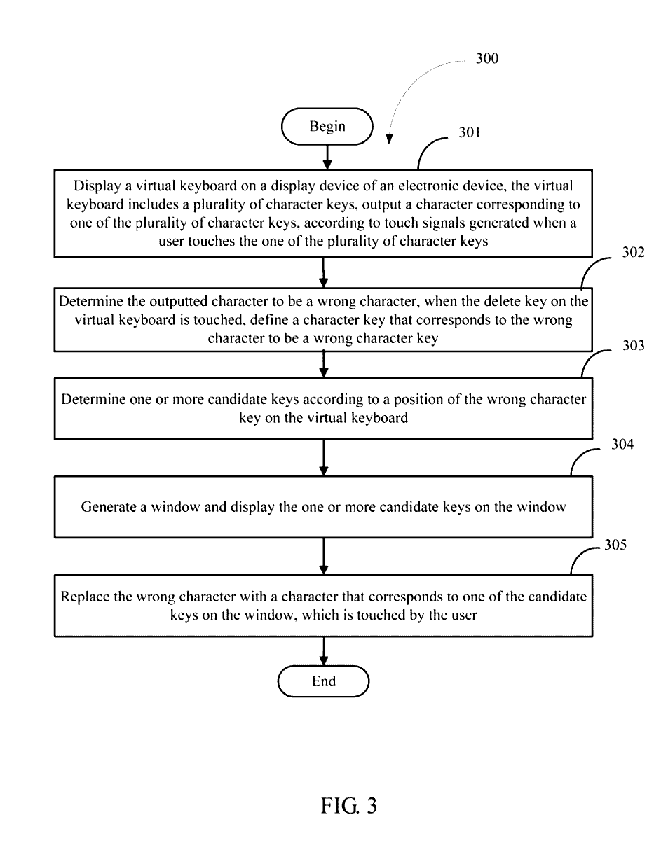

FIG. 2 illustrates a block diagram of one embodiment of modules included in the correcting system 120. In at least one embodiment, the correcting system 120 can include an outputting module 121, a determining module 122, a display module 123, and a correcting module 124. The modules 1121-124 can include computerized codes in a form of one or more programs, which are stored in the storage device 12, and are executed by the at least one processor 10. Details will be provided in conjunction with a flow chart of FIG. 3 in the following paragraphs.

FIG. 3 illustrates a flowchart of one embodiment of a method of correcting a character. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods or subroutines, carried out in the exemplary method 300. Additionally, the illustrated order of blocks is by example only and the order of the blocks can be changed according to the present disclosure. The exemplary method 300 can begin at block 301. Depending on the embodiment, additional steps can be added, others removed, and the ordering of the steps can be changed.

At block 301, the outputting module 121 can display a virtual keyboard on the display device 11. In at least one embodiment, the virtual keyboard can include, but are not limited to, a plurality of character keys, and one or more function keys. The plurality of character keys may include, but are not limited to, the keys that correspond to 26 letters, i.e., A, B, C, D, E, F . . . Z. The one or more function keys may include, but are not limited to, a delete key, and a control key.

The outputting module 121 can output a character corresponding to one of the plurality of character keys, according to touch signals generated when the user touches the one of the plurality of character keys.

At block 302, the determining module 122 can determine the outputted character to be a wrong character, when the delete key on the virtual keyboard is touched.

In one embodiment, when the user continuously touches more than one character keys or the user touches one character key for more than one times on the virtual keyboard, the determining module 122 determines the last character that is outputted to be the wrong character.

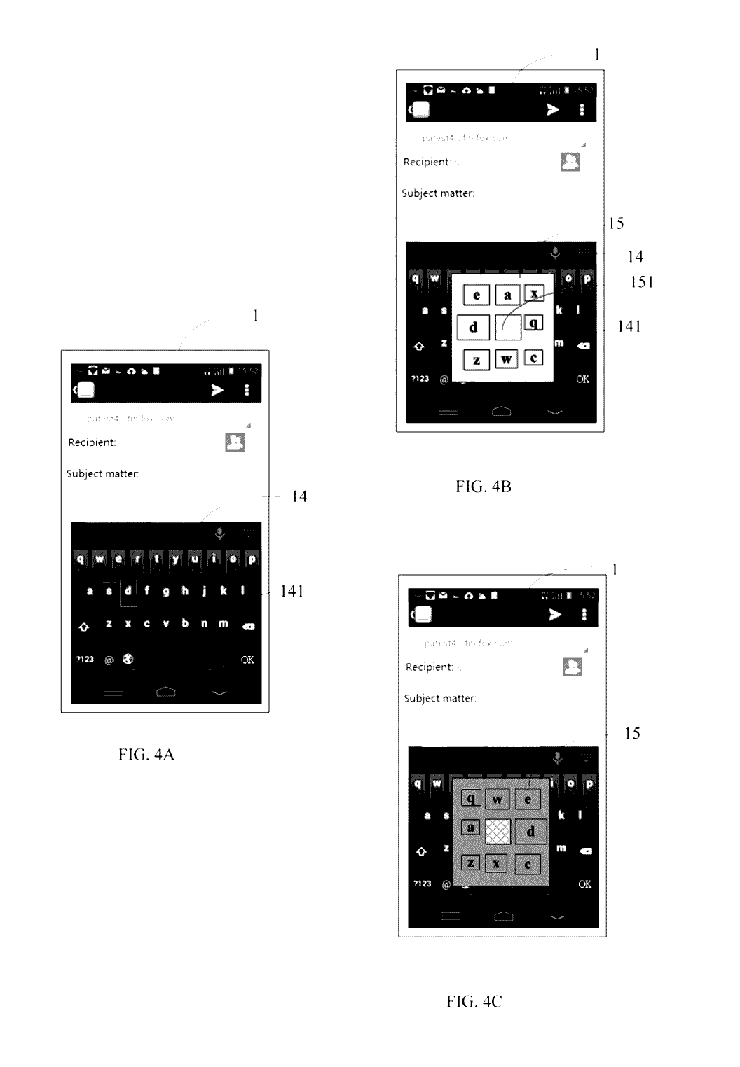

For example, as shown in FIG. 4A, it is assumed that the user plans to input a character “d” using a virtual keyboard 14. However, because the user carelessly touches a character key that corresponds to a character “s”, the character “s” is outputted by the outputting module 121. When the user finds that the character “s” is wrongly inputted, the user can touch a delete key 141 on the virtual keyboard 14. Then the determining module 122 can determine the character “s” is the wrong character according to touch signals generated when the user touches the delete key 141.

In order to describe conveniently, the character key corresponding to the wrong character is referred to as “wrong character key” hereinafter.

At block 303, the determining module 122 can determine one or more candidate keys according to a position of the wrong character key on the virtual keyboard. The one or more candidate keys may include the correct character key that the user originally intended to touch on the virtual keyboard.

In one embodiment, the one or more candidate keys include all character keys located in a predetermined range around the position of the wrong character key on the virtual keyboard.

In one embodiment, the one or more candidate keys include a nearest character key that locates at an up side of the wrong character key, a nearest character key that locates at a down side of the wrong character key, a nearest character key that locates at a left side of the wrong character key, and a nearest character key that locates at a right side of the wrong character key on the virtual keyboard.

In other embodiments, the one or more candidate keys further include four nearest character keys that locate on two diagonals. An intersection of the two diagonals is the position of the wrong character key on the virtual keyboard.

For example, as shown in FIG. 4A, the determining module 122 can determine the one or more candidate keys include the character keys that respectively correspond to the characters “q”, “a”, “z”, “w”, “x”, “e”, “d”, “c”.

In one embodiment, the determining module 122 can further sort the candidate keys in an ascending order or a descending order, according to the touch area corresponding to each of the candidate keys. In one embodiment, the determining module 122 can determine the touch area corresponds to each of the candidate keys, according to the strength or the number of touch signals generated by each of the candidate keys when the user touches the wrong character key.

The touch area corresponds to each of the candidate keys represents the probability of the original intention of the user to touch each of the candidate keys. The bigger the touch area corresponds to a candidate key is, the greater the probability corresponding to the candidate key is.

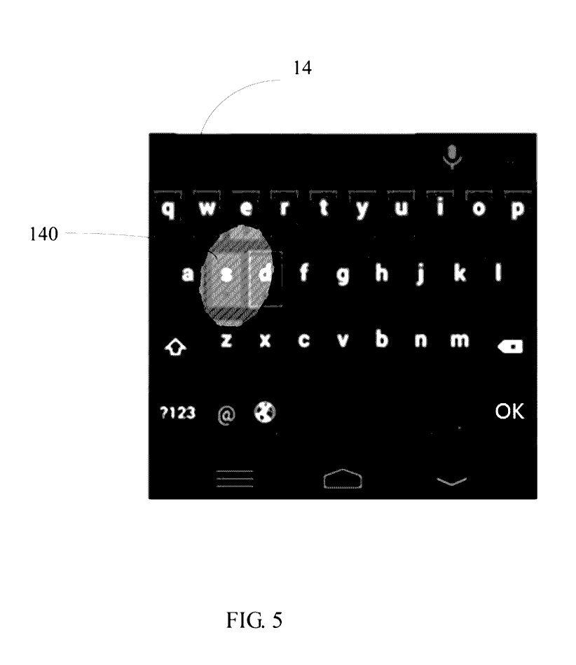

For example, as shown in FIG. 5, it is assumed that when the user inputs the wrong character “s”, the user touches the virtual keyboard 140 with an area 140. The determining module 122 can sort the candidate keys in descending order of the touch areas of the candidate keys, e.g., the characters respectively corresponding to the characters “d”, “e”, “z”, “a”, “w”, “x”, “q”, “c”.

At block 304, the display module 123 can generate a window 15, and display the one or more candidate keys on the window 15.

In one embodiment, the display module 123 can display the one or more candidate keys on the window 15 according to a preset usage pattern. In one embodiment, the preset usage pattern can be a left hand usage pattern or a right hand usage pattern. When the usage pattern is preset to be the left hand usage pattern, the display module 123 can display the candidate keys whose touch areas are bigger on the left side of the window 15, and display the candidate keys whose touch areas are smaller on the right side of the window 15. On the other hand, when the usage pattern is preset to be the right hand usage pattern, the display module 123 can display the candidate keys whose touch areas are bigger on the right side of the window 15, and display the candidate keys whose touch areas are smaller on the left side of the window 15.

For example, as shown in FIG. 4B, it is assumed that the usage pattern is preset to be the left hand usage pattern, the display module 123 can classify the above eight candidate keys (i.e., the character keys respectively correspond to the characters “d”, “e”, “z”, “a”, “w”, “x”, “q”, “c” ) into three groups. The character keys respectively correspond to the characters “d”, “e”, “z” whose touch areas are bigger are classified into a first group by the display module 123. The character keys respectively correspond to the characters “a”, “w” whose touch areas are less bigger are classified into a second group by the display module 123. The character keys respectively correspond to the characters “x”, “q”, “c” whose touch areas are smaller are classified into a third group by the display module 123. The display module 123 can further display the three groups of character keys with three lines and three columns on the window 15 as shown in FIG. 4B.

In one embodiment, a size of each of the candidate keys on the window 15 is in direct proportion to the touch area corresponds to each of the candidate keys.

In one embodiment, the display module 123 can further generate a control key 151 and display the control key 151 on the window 15.

In other embodiments, the display module 123 can also display the candidate keys on the window 15 according to a position of each of the candidate keys on the virtual keyboard 14. In other words, the position of each of the candidate keys on the window 15 is the same as the position of each of the candidate keys on the virtual keyboard 14.

For example, as shown in FIG. 4C, the display module 123 can display the eight candidate keys (i.e., the character keys that respectively correspond to characters “q”, “a”, “z”, “w”, “x”, “e”, “d”, “c”.) on the window 15 according to the position of each of the candidate keys on the virtual keyboard 14.

At block 304, the correcting module 124 can replace the wrong character with the character corresponding to the candidate key touched by the user on the window 15.

For example, when the user touches the character key that corresponds to the character “d” on the window 15, the correcting module 143 can replace the wrong character “s” with the character “d”.

The correcting module 124 can close the window 15 and return to the virtual keyboard 14 when the user touches the control key 151.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A character correcting method for an electronic device, the method comprising:
displaying a virtual keyboard on a display device of the electronic device, wherein the virtual keyboard comprises a plurality of character keys;
outputting, at the electronic device, a character corresponding to one of the plurality of character keys, according to touch signals generated when the one of the plurality of character keys is touched;
determining, at the electronic device, the outputted character to be a wrong character, when a delete key on the virtual keyboard is touched, wherein a character key that corresponds to the wrong character is defined to be a wrong character key;
determining, at the electronic device, a plurality of candidate keys according to a position of the wrong character key on the virtual keyboard;
generating, at the display device, a window and displaying the candidate keys on the window; and
replacing, at the display device, the wrong character with a character corresponding to one of the candidate keys touched on the window.

2. The method according to claim 1, wherein the candidate keys comprise all character keys located in a predetermined range around the position of the wrong character key on the virtual keyboard.

3. The method according to claim 1, wherein the candidate keys are displayed on the window according to touch areas of the candidate keys, wherein the touch areas are determined according to touch signals generated by the candidate keys when the user touches the wrong character key.

4. The method according to claim 1, wherein the candidate keys are displayed on the window according to a position of each of the candidate keys on the virtual keyboard.

5. The method according to claim 1, wherein a size of each of the candidate keys on the window is in direct proportion to a touch area corresponding to each of the candidate keys.

6. The method according to claim 1, further comprising:
generating a control key and displaying the control key on the window; and
closing the window and returning to the virtual keyboard when the control key is touched.

7. An electronic device comprising:
at least one processor;
a storage device being configured to store one or more programs that, when executed by the at least one processor, cause the at least one processor to:
display a virtual keyboard on a display device of the electronic device, wherein the virtual keyboard comprises a plurality of character keys;
output a character corresponding to one of the plurality of character keys, according to touch signals generated when the one of the plurality of character keys is touched;
determine the outputted character to be a wrong character, when a delete key on the virtual keyboard is touched, wherein a character key that corresponds to the wrong character is defined to be a wrong character key;
determine a plurality of candidate keys according to a position of the wrong character key on the virtual keyboard;
generate a window and display the candidate keys on the window; and
replace the wrong character with a character corresponding to one of the candidate keys touched on the window.

8. The electronic device according to claim 7, wherein the candidate keys comprise all character keys located in a predetermined range around the position of the wrong character key on the virtual keyboard.

9. The electronic device according to claim 7, wherein the candidate keys are displayed on the window according to touch areas of the candidate keys, wherein the touch areas are determined according to touch signals generated by the candidate keys when the user touches the wrong character key.

10. The electronic device according to claim 7, wherein the candidate keys are displayed on the window according to a position of each of the candidate keys on the virtual keyboard.

11. The electronic device according to claim 7, wherein a size of each of the candidate keys on the window is in direct proportion to a touch area corresponding to each of the candidate keys.

12. The electronic device according to claim 7, wherein the at least one processor is further caused to:
generate a control key and display the control key on the window; and
close the window and return to the virtual keyboard when the control key is touched.

13. A non-transitory storage medium having stored thereon instructions that, when executed by a processor of an electronic device, causes the processor to perform a character correcting method, wherein the method comprises:
displaying a virtual keyboard on a display device of the electronic device, wherein the virtual keyboard comprises a plurality of character keys;
outputting a character corresponding to one of the plurality of character keys, according to touch signals generated when the one of the plurality of character keys is touched;
determining the outputted character to be a wrong character, when a delete key on the virtual keyboard is touched, wherein a character key that corresponds to the wrong character is defined to be a wrong character key;
determining a plurality of candidate keys according to a position of the wrong character key on the virtual keyboard;
generating a window and displaying the candidate keys on the window; and
replacing the wrong character with a character corresponding to one of the candidate keys touched on the window.

14. The non-transitory storage medium according to claim 13, wherein the candidate keys comprise all character keys located in a predetermined range around the position of the wrong character key on the virtual keyboard.

15. The non-transitory storage medium according to claim 13, wherein the candidate keys are displayed on the window according to touch areas of the candidate keys, wherein the touch areas are determined according to touch signals generated by the candidate keys when the user touches the wrong character key.

16. The non-transitory storage medium according to claim 13, wherein the candidate keys are displayed on the window according to a position of each of the candidate keys on the virtual keyboard.

17. The non-transitory storage medium according to claim 13, wherein a size of each of the candidate keys on the window is in direct proportion to a touch area corresponding to each of the candidate keys.

18. The non-transitory storage medium according to claim 13, wherein the method further comprises:
generating a control key and displaying the control key on the window; and
closing the window and returning to the virtual keyboard when the control key is touched.
